(19) United States
(12) Patent Application Publication
(10) Pub. No.: US 2024/0173186 A1
(43) Pub. Date: May 30, 2024

(54) FOLDABLE INFLATABLE HYPERBARIC CHAMBER

(71) Applicant: BARIKS HEALTH LTD, Sapirim Industrial Park (IL)

(72) Inventors: Boaz MISHOLI, Tel Aviv-Yafo (IL); Roee SHERRER, Sde Nitzan (IL); Rami BARGIL, Kibbutz Nirim (IL)

(21) Appl. No.: 18/428,053

(22) Filed: Jan. 31, 2024

Related U.S. Application Data
(63) Continuation-in-part of application No. PCT/IL2022/050835, filed on Aug. 2, 2022.
(60) Provisional application No. 63/228,428, filed on Aug. 2, 2021.

(51) Int. Cl. A61G 10/02

(52) U.S. Cl. CPC A61G 10/026

(57) ABSTRACT

The present disclosure provides a hyperbaric chamber that is capable of folding and unfolding, thereby reducing and increasing its inner volume, respectively. The inner volume is confined by a structural body and optionally also by top and bottom structural covers having a dome shape and being coupled to a structural body. The structural body, i.e., the structure that extends along a longitudinal axis of the chamber and grants the chamber a substantial portion of its geometric stability when the hyperbaric chamber is inflated with pressurized gas. The structural body is formed of two types of regions, a first, non-transparent region and a second, at least partially transparent region, both regions are reinforced to a degree for withstanding the desired internal pressure, namely a pressure difference between the internal volume of the chamber and the ambient pressure.

### CROSS REFERENCE TO RELATED APPLICATIONS

This is a continuation-in-part of International Patent Application Number PCT/IL2022/050835 filed on Aug. 2, 2022, which claimed priority to U.S. Provisional Patent Application Ser. No. 63/228,428 filed on Aug. 2, 2021, where the entire contents of both of said applications are incorporated by reference herein.

### TECHNICAL FIELD

The presently disclosed subject matter relates to the field of hyperbaric chambers and, more particularly, to the field of foldable inflatable hyperbaric chambers.

### BACKGROUND

Hyperbaric oxygen therapy involves breathing almost pure oxygen under increased atmospheric pressure, in a dedicated room or chamber. This treatment is typically applied, inter alia, to heal of carbon monoxide poisoning, gangrene, stubborn wounds, and infections in which tissues are starved for oxygen.

Medical facilities typically accommodate conventional heavy, rigid hyperbaric chambers. Moving these chambers to a remote location can be cumbersome or even impossible mission. To overcome this obstacle, collapsible hyperbaric chamber systems have been proposed as portable units. In order to provide comfort to the patient and to be able to see the patient during the treatment, the chambers are required to be equipped with transparent viewing windows. Providing windows that do not deform and fail under high pressure (e.g., 10 atm) is one of the challenges in collapsible hyperbaric chambers.

Therefore, there is a growing need to provide a new foldable inflatable hyperbaric chamber.

References considered to be relevant as background to the presently disclosed subject matter are briefly described below. Acknowledgement of the references herein is not to be inferred as meaning that these are in any way relevant to the patentability of the presently disclosed subject matter.

WO Application Publication No. WO2020162839, belongs to the field of hyperbaric chambers for performing hyperbaric and hyperbaric-oxygen therapies for medical or non-medical purposes, more precisely to the field of constructional execution of flexible-inflatable hyperbaric chambers. The essence of the inflatable hyperbaric chamber with a multilayer structure according to the invention is in the three-layer structure and in separable connection of individual layers of the said structure as well as functional elements, which allows the chamber to operate at a pressures between 130 kPa (1.3 bar) and 300 kPa (3.0 bar). The three-layer structure consists of an inner bag for sealing, an outer bag for protection and relief of the inner bag and which maintains the shape of the chamber, as well as a grid for maintaining the structure and even distribution of forces.

U.S. Pat. No. 5,678,543 discloses a lightweight hyperbaric chamber capable of maintaining pressures of up to 22 psi greater than ambient through the use of at least two zippers, at least one of which is a sealing zipper, and preferably with heavy fabric and a reinforcing outer layer.

US Patent Publication No. US20080006272 discloses a hyperbaric chamber that includes a collapsible, pressurizable bladder and an inflatable support member supporting the bladder in a substantially uncollapsed configuration. The inflatable support member may be either internal or external to the bladder, and, in embodiments, is a rib with curvature corresponding generally to the uncollapsed shape of the bladder. A stiffening stave may provide additional support. The bladder further includes an accessway into the interior thereof and a substantially non-breathable closure on the accessway. The closure includes a substantially air-impermeable gasket sandwiched between first and second zippers. A reinforcing zipper may provide additional strength to the closure. Similarly, a reinforcing harness substantially surrounding the bladder may provide additional strength to the bladder. A source of compressed air is in fluid communication with the interior of the bladder, and a cooling source may also be provided.

CN Utility Model No. CN211912090U discloses a portable hyperbaric oxygen cabin device. The utility model discloses an adopt the setting of the cabin body that polyurethane composite environmental protection material made, can conveniently use through filling into compressed air, when not using, can conveniently fold the arrangement, through the setting of oxygen pipeline plug and air pipeline plug, make the cabin body can conveniently be connected with oxygen mask and the air supply system who includes compressed air equipment and oxygenerator, through the setting of constant voltage relief valve, can keep the internal pressure of cabin invariable 1.2-1.3 atmospheric pressure, be applicable to hyperbaric oxygen therapy. The utility model discloses the usable synergism of the oxygen of pressure that is higher than atmospheric pressure slightly and high concentration makes dissolved oxygen improve, improves organ oxygen supply efficiency, promotes human metabolism, and the effectual low in manufacturing cost that carries out hyperbaric oxygen and treat, safe and reliable uses easy operation, and convenient the taking in carries, saves space, does not receive the place of use restriction, easily universalization uses widely.

### GENERAL DESCRIPTION

The present disclosure provides, in at least one of its aspects, a hyperbaric chamber that is capable of folding and unfolding, thereby reducing and increasing its inner volume, respectively. The inner volume is confined by a structural body and optionally also by top and bottom domes being coupled to the structural body. The hyperbaric chamber includes a structural body, i.e., the structure that extends along a longitudinal axis of the chamber and grants the chamber a substantial portion of its geometric stability when the hyperbaric chamber is inflated with pressurized gas. In a first configuration, the structural body is formed of two types of regions, a first, non-transparent region and a second, at least partially transparent region. The first region comprises a first reinforcing flexible material that is coated by a first polymeric material on one or two of its sides/faces such that it is impermeable to fluid. The second region comprises an internal layer or sheet of a second, at least partially transparent polymeric material (in the visual spectrum) and an external layer or sheet of mesh of a second reinforcing flexible material. The first and the second layers of each second region are attached to portions of the first region. The first and the second layers or sheets are distinct and are not part of the same material or form together a composite material. Each layer is constituted by an independent sheet and are attached to one another only in the areas to which they are attached to the first region. Therefore, when the hyperbaric chamber is inflated, the internal sheet urges against the external sheet. By this design of the second region, the at least partially transparent polymeric material is not deformed in such a way that can affect its transparency properties and allows a subject in the interior of the inflated chamber to see through the at least partially transparent polymeric material and through the mesh of the second reinforcing flexible material. The first layer or sheet is attached to the first region so as to form a consecutive impermeable structure to fluid and the second layer or sheet is attached to the first region such that it provides durability to the second region to allow it to withstand high pressure differences between the internal of the chamber and the ambient pressure. The attachment of the first region to the second region can be made by many known techniques that yield the desired result, such as by welding. It is to be noted that there can be a plurality of first and second regions. Typically, there is a consecutive first region and one or more second regions embedded within portions of the first region. The mesh of the external layer forms a formation that comprises an array of window-like frames that are sufficiently large to allow a subject that is in the interior of the chamber to see through them to the exterior of the chamber.

In a second configuration of the structural body at least a portion of the structural body comprises a reinforcing mesh that is embedded within a polymeric material. The reinforcing mesh defines window-like portions of equal or varying sizes that are filled with the polymeric material. Typically, the polymeric material is transparent or at least semi-transparent for the visible spectrum to allow bilateral visualization into and from the chamber. The structural body is made of materials allowing it to (i) withstand pressure difference between the inner volume of the chamber and the ambient pressure and (ii) fold to reduce its size for efficient logistics and storage.

The hyperbaric chamber further includes a sealable opening for allowing a subject to enter and exit the inner volume of the chamber. Once the opening is sealed, the pressure difference between the inner volume of the chamber and the ambient pressure is maintained.

Thus, in accordance with a first aspect of the presently disclosed subject matter, there is provided a foldable inflatable hyperbaric chamber comprising: a structural body that comprises a polymeric material layer, and a reinforcing mesh made embedded within the polymeric material layer that is formed by connected strands of one or more synthetic fibers defining closely spaced frames therebetween; a sealable opening for allowing a subject to enter and exit an inner volume of the hyperbaric chamber.

It is to be noted that any combination of the described embodiments (sometimes referred as cases) with respect to any aspect of this present disclosure is applicable. In other words, any aspect of the present disclosure can be defined by any combination of the described embodiments.

In some cases, the polymer material is at least semi-transparent polymer allowing visualization therethrough.

The chamber can further comprise two hemi-spherical structural elements that are firmly coupled to opposite sides of the structural body (e.g., welded thereto) at coupling portion, wherein the two hemi-spherical structural elements and the structural 5 body enclosing said inner volume.

The chamber can optionally further comprise one or more reinforcing rings applied on at least a part of the coupling portion.

The chamber can optionally further comprise one or more of: an air/oxygen flow valve, an over-pressure relief valve or ventilation valve, therefore allowing gas exchange between the inner volume of the chamber and either the ambient or a gas source, e.g., oxygen gas source.

In some cases, the structural body further comprising one or more of: an oxygen sensor, a temperature sensor or a pressure sensor. The sensed parameters are monitored by a processor and the processor is configured to control the conditions in the inner volume to maintain each of the sensed parameters within a selected range. For example, the processor is configured to operate a pressure generator (e.g., a compressor) linked to the inner volume to maintain a desired pressure range within the inner volume of the cell.

In some cases, the sealable opening further comprising a first zip fastener configured to prevent gas exchange between the inner volume and the ambient environment.

In some cases, the sealable opening further comprising a second zip fastener, outer with respect to the first zip fastener, configured to withstand stress forces experienced by the chamber when inflated by gas.

In some cases, the sealable opening is formed, at least partially on the reinforcing mesh portion.

In some cases, the polymer material is a Thermoplastic polyurethane (TPU).

In some cases, the reinforcing mesh is woven utilizing a Leno weave technique.

In some cases, the synthetic fibers are Aromatic polyamide fibers.

In some cases, the reinforcing mesh is embedded within the polymeric material by a Calendering process.

In some cases, the structural body further comprising an adjustable seat configured to support the subject in two or more selectable seating configurations.

In some cases, the adjustable seat is anchored to at least one anchoring point at the structural body, the seat comprises at least one joint portions for allowing adjusting position or inclination thereof.

In some cases, the structural body is configured to withstand a pressure difference between the inner volume and the ambient pressure of up to approximately 9 bar.

The chamber can further comprise an inflatable skeleton such that upon inflation thereof it spreads the structural body and defines its unfolded shape. In some cases, the inflatable skeleton can be further configured to support the chamber in its unfolded shape (e.g., before and/or after the chamber is inflated with pressurized gas).

In some cases, the inflatable skeleton comprises a top inflatable toroid and a bottom inflatable toroid linked by two or more longitudinal tubes, the inflatable toroids define an inner volume radius of the chamber, and the inflatable tubes define an inner volume longitudinal length. Thus, the torids substantially circumferentially surrounding the inner volume of the hyperbaric chamber and the tubes extend substantially along the longitudinal length of the hyperbaric chamber.

In some cases, the toroids can be disposed within the inner volume of the chamber to internally support the structural body.

In some cases, the one or more inflatable tubes extending from the inflatable toroid and substantially orthogonal thereto.

In some cases, the one or more inflatable tubes extend, at least partially, external to the inner volume to externally support the structural body.

In accordance with a second aspect of the presently disclosed subject matter, there is provided a foldable inflatable hyperbaric chamber comprising: a structural body that comprises: at least semi-transparent polymeric material layer allowing visualization therethrough, and a reinforcing mesh made embedded within the polymeric material layer that is formed by connected strands of one or more synthetic fibers defining closely spaced frames therebetween; a sealable opening for allowing a subject to enter and exit an inner volume of the hyperbaric chamber.

In accordance with a third aspect of the presently disclosed subject matter, there is provided an inclination assembly for supporting a foldable inflatable hyperbaric chamber, comprising: an elongated support arrangement extending between first and second ends and configured for coupling with the foldable inflatable hyperbaric chamber, said support arrangement comprises a rigid frame defining a frame enclosure sized for supporting said foldable inflatable hyperbaric chamber; an inclination mechanism for allowing controlling the inclination of the elongated support arrangement along a range of inclination positions.

In some cases, the elongated support arrangement comprises one or more supporting sheets fixed to the rigid frame to fit within at least a portion of the frame enclosure.

In some cases, the first end is pivotally coupled, e.g., by coupling two rigid frame members, to a first anchoring structure, and the inclination mechanism is pivotally coupled to a coupling portion of the rigid frame other than the first end.

In some cases, the coupling portion is defined between the first and second ends, more proximal to the second end.

In some cases, the inclination mechanism is formed of two segments pivotally coupled to one another at a segment coupling portion, the first segment is coupled to the coupling portion other than the segment coupling portion, and the second segment is coupled to a second anchoring structure other than the segment coupling portion. Thus, the inclination mechanism comprises three joints allowing rotation about three parallel axes. A first joint in the coupling portion, a second joint at the segment coupling portion and a third joint at the coupling of the second segment with the second anchoring structure.

In some cases, the inclination mechanism is switchable between two inclination positions, a first inclination position forms a selected angle between a frame plane defined by the rigid frame and a horizontal plane, a second inclination position in which the frame plane is co-planar with the horizontal plane.

In some cases, the segment coupling portion is configured to engage the ground in the second inclination position to provide additional support.

In some cases, the inclination assembly further comprising a container sized for containing said inclination assembly, said container comprises said first and second anchoring structures.

In some cases, the rigid frame is formed of a plurality of rigid frame members coupled to one another.

In accordance with a fourth aspect of the presently disclosed subject matter, there is provided a foldable inflatable hyperbaric chamber comprising: a structural body enclosing an inner volume at least partially formed by a collapsible flexible reinforcing mesh coated by a polymer material layer; wherein the reinforcing mesh is formed by connected strands of one or more synthetic fibers defining closely spaced frames therebetween; wherein each frame comprises a respective portion of the polymer material therein, thereby forming viewports; a sealable opening for allowing a subject to enter and exit said inner volume of the hyperbaric chamber.

Yet another aspect of the present disclosure provides a foldable inflatable hyperbaric chamber. The foldable chamber comprising a structural body comprises at least one first, non-transparent regions and at least one, at least partially transparent regions. The first region comprises a sheet of a first reinforcing flexible material coated by a first polymeric material on one or two of its sides/faces so as to yield fluid-impermeable and durable region. The second region comprises an internal layer, namely the layer that faces the interior of the chamber, of a second, at least partially transparent in the visual spectrum, polymeric material and an external layer of reinforcing mesh of a second reinforcing flexible material that is formed by connected strands of fibers of said second reinforcing flexible material, defining closely spaced frames therebetween, i.e. windows-like shapes frames. The first and the second layers of each second region are attached to portions of the first region forming together a fluid-impermeable structural body. The chamber further comprising a sealable opening for allowing a subject to enter and exit an inner volume of the hyperbaric chamber.

In some embodiments of the hyperbaric chamber, the first reinforcing material and the second reinforcing material are the same.

In some embodiments of the hyperbaric chamber, each of the first and the second reinforcing materials are independently selected from: Kevlar (aramid or para-aramid), nylon, polyester and Ultra-high-molecular-weight polyethylene (UHMWPE).

In some embodiments of the hyperbaric chamber, the first polymeric material and the second polymeric material are the same.

In some embodiments of the hyperbaric chamber, each of the first and second polymeric materials are flexible and air impermeable.

In some embodiments of the hyperbaric chamber, each of the first and second polymeric materials are independently selected from: Thermoplastic polyurethane (TPU) and Polyvinyl chloride (PVC), preferably TPU.

In some embodiments of the hyperbaric chamber, the structural body is cylindrical. Namely, the structural body forms the cylindrical part of the chamber, and it is opened from both sides. It is required to attach to both of its ends/sides covers to sealingly confine the inner volume.

In some embodiments, the hyperbaric chamber further comprising two structural covers attached to opposite sides of the structural body along respective attachment portions, thereby the two structural covers and the structural body confining said inner volume.

In some embodiments of the hyperbaric chamber, said two structural covers have a hemi-spherical shape when the chamber is inflated.

In some embodiments, the hyperbaric chamber further comprising one or more reinforcing rings applied on at least a part of the coupling portion.

In some embodiments of the hyperbaric chamber, the attachment portions comprises one or more first elastic bands applied on one of the faces of the structural body and one or more second elastic bands applied on one of the faces of the structural covers. The attachment portion further comprises a plurality of sewing patterns, each sewing together a first band to a second band via all faces of the structural body and the respective structural cover. This type of attachment typically results that the first failing of the chamber will occur at the attachment portion and will cause a mild leak of air from the chamber instead of an explosion of the chamber, which makes the chamber safe.

In some embodiments of the hyperbaric chamber, the one or more first elastic bands are applied on the external face of the structural body.

In some embodiments of the hyperbaric chamber, each sewing pattern is a closed shape, e.g. a circle or any closed polygon.

In some embodiments of the hyperbaric chamber, the first elastic band is a single band applied on the entire perimeter of the structural body.

In some embodiments of the hyperbaric chamber, the second elastic band is a single band applied to the perimeter of the structural.

In some embodiments of the hyperbaric chamber, the one or more second elastic bands applied on one of the faces of the structural covers are a plurality of segments forming a non-consecutive pattern of attachment. Namely, there are a plurality of segments applied one after another at the inner or outer circumference of the structural cover and/or the structural body.

In some embodiments, the hyperbaric chamber further comprising one or more of: an air/oxygen flow valve, an over-pressure relief valve or ventilation valve.

In some embodiments, the hyperbaric chamber further comprising one or more of: an oxygen sensor, a temperature sensor or a pressure sensor.

In some embodiments of the hyperbaric chamber, the sealable opening further comprising a first zip fastener configured to prevent gas passage between the structural body and its surroundings.

In some embodiments of the hyperbaric chamber, the sealable opening further comprising a second zip fastener configured to withstand stress forces experienced by the chamber when inflated by gas.

In some embodiments of the hyperbaric chamber, the sealable opening is located at the first region.

In some embodiments of the hyperbaric chamber, the reinforcing mesh is woven.

In some embodiments of the hyperbaric chamber, the reinforcing mesh is woven utilizing a Leno weave technique.

In some embodiments of the hyperbaric chamber, the reinforcing mesh is at least coated with a third polymeric material to stiffen the mesh formation. Typically, the mesh is soaked in a hot liquified polymer and then letting the polymer to solidify on and within the mesh, rendering the mesh formation stiffer to maintain its desired formation even after inflation of the chamber.

In some embodiments, the third polymeric material is same as the first or second polymeric materials.

In some embodiments, the third polymeric material is TPU.

In some embodiments of the hyperbaric chamber, the synthetic fibers are Aromatic polyamide fibers.

In some embodiments of the hyperbaric chamber, the first region is prepared by a Calendaring process.

In some embodiments, the hyperbaric chamber comprising an adjustable seat configured to support the subject.

In some embodiments of the hyperbaric chamber, the adjustable seat is anchored to at least one anchoring point at the structural body, the seat comprises at least one joint portions for allowing adjusting position or inclination thereof.

In some embodiments of the hyperbaric chamber, the adjustable seat is configured to be adjusted between a standby state, in which at least part of it protrudes from the inner volume, thereby allowing the subject using the chamber to easily sit on the seat, and an operation state, in which the seat is entirely accommodated within the inner volume.

In some embodiments of the hyperbaric chamber, the structural body is configured to withstand a relative air pressure of up to approximately 9 bar.

In some embodiments, the hyperbaric chamber further comprising an inflatable skeleton such that upon inflation thereof it spreads the structural body and defines its unfolded shape.

In some embodiments of the hyperbaric chamber, the inflatable skeleton comprises a top inflatable toroid and a bottom inflatable toroid linked by two or more longitudinal tubes, the inflatable toroids define an inner volume radius of the chamber and the inflatable tubes define an inner volume longitudinal length.

In some embodiments of the hyperbaric chamber, the toroids are disposed within the inner volume to internally support the structural body.

In some embodiments of the hyperbaric chamber, the one or more inflatable tubes extending from the inflatable toroid and substantially orthogonal thereto.

In some embodiments of the hyperbaric chamber, the one or more inflatable tubes extend, at least partially, external to the inner volume to externally support the structural body.

In some embodiments, the hyperbaric chamber comprising a grid of reinforcing bands embracing the portions of the first and second regions and the structural covers.

Yet another aspect of the present disclosure provides a foldable inflatable hyperbaric chamber. The chamber comprising (i) a structural body; (ii) two structural covers attached to two opposite sides/ends of the structural body along respective attachment portions, thereby confining together with the structural body an inner volume; and (iii) a sealable opening for allowing a subject to enter and exit an inner volume of the hyperbaric chamber. The attachment portions comprises one or more first elastic bands applied on one of the faces of the structural body and one or more second elastic bands applied on one of the faces of the structural covers. The attachment portion further comprises a plurality of sewing patterns, each sewing together a first band to a second band via all faces of the structural body and the respective structural cover.

In some embodiments of the hyperbaric chamber, the one or more first elastic bands are applied on the external face of the structural body.

In some embodiments of the hyperbaric chamber, each sewing pattern is a closed shape, e.g. a circle or any closed polygon.

In some embodiments of the hyperbaric chamber, the first elastic band is a single band applied on the entire perimeter of the structural body.

In some embodiments of the hyperbaric chamber, the second elastic band is a single band applied to the perimeter of the structural covers.

Yet another aspect of the present disclosure provides an assembly for supporting a foldable inflatable hyperbaric chamber and allowing inclination adjustment of the chamber. The assembly comprising: (i) a base; and (ii) one or more arms coupled to said base and are configured to be coupled with one or more coupling locations at the external surface of said hyperbaric chamber. It is to be noted that coupling via other coupling elements that are coupled to the external surface of the chamber are encompassed under this definition. The one or more arms are adjustable between various states, which the combination of the states of different arms, defines the inclination of the chamber.

In some embodiments, the assembly comprising one or more auxiliary arms connecting two or more of said coupling locations, thereby allowing an accurate and at times more limited inclination adjustment.

In some embodiments of the assembly, said one or more arms comprise one or more couples of arms, each arm of the couple is coupled to a respective coupling location opposite to the coupling location of the other arm of the couple. Each couple is typically adjusted at a similar manner that forms a symmetric rotation of the chamber, thereby affect its inclination.

In some embodiments of the assembly, said one or more arms are rotatably coupled to the base to allow said adjustability between various states. In other words, the rotational states of the arms define the inclination state of the chamber.

In some embodiments of the assembly, said one or more arms are rotatably coupled to the coupling locations.

### EMBODIMENTS

The following are optional embodiments and combinations thereof in accordance with aspects of the present disclosure:
1. A foldable inflatable hyperbaric chamber comprising:
   a structural body that comprises:
      a polymeric material layer, and
      a reinforcing mesh made embedded within the polymeric material layer that is formed by connected strands of one or more synthetic fibers defining closely spaced frames therebetween:
   a sealable opening for allowing a subject to enter and exit an inner volume of the hyperbaric chamber.
2. The hyperbaric chamber of claim 1, wherein the polymer material is at least semi-transparent polymer allowing visualization therethrough.
3. The hyperbaric chamber of claim 1 or 2, further comprising two hemi-spherical structural elements are firmly coupled to opposite sides of the structural body coupling portion, wherein the two hemi-spherical structural elements and the structural body enclosing said inner volume.
4. The hyperbaric chamber of claim 3, further comprising one or more reinforcing rings applied on at least a part of the coupling portion.
5. The hyperbaric chamber of any one of claims 1-4, further comprising one or more of: an air/oxygen flow valve, an over-pressure relief valve or ventilation valve.
6. The hyperbaric chamber of any one of claims 1-5, wherein the structural body further comprising one or more of: an oxygen sensor, a temperature sensor or a pressure sensor.
7. The hyperbaric chamber of any one of claims 1-6, wherein the sealable opening further comprising a first zip fastener configured to prevent gas passage between the structural body and its surroundings.
8. The hyperbaric chamber of any one of claims 1-7, wherein the sealable opening further comprising a second zip fastener configured to withstand stress forces experienced by the chamber when inflated by gas.
9. The hyperbaric chamber of any one of claims 1-8, wherein the sealable opening is located, at least partially, on the reinforcing mesh portion.
10. The hyperbaric chamber of any one of claims 1-9, wherein the polymer material is a Thermoplastic polyurethane (TPU).
11. The hyperbaric chamber of any one of claims 1-10, wherein the reinforcing mesh is woven utilizing a Leno weave technique.
12. The hyperbaric chamber of any one of claims 1-11, wherein the synthetic fibers are Aromatic polyamide fibers.
13. The hyperbaric chamber of any one of claims 1-12, wherein the reinforcing mesh is embedded within the polymeric material by a Calendaring process.
14. The hyperbaric chamber of any one of claims 1-13, wherein the structural body further comprising an adjustable seat configured to support the subject.
15. The hyperbaric chamber of claim 14, wherein the adjustable seat is anchored to at least one anchoring point at the structural body, the seat comprises at least one joint portions for allowing adjusting position or inclination thereof.
16. The hyperbaric chamber of any one of claims 1-15, wherein the structural body is configured to withstand a relative air pressure of up to approximately 9 bar.
17. The hyperbaric chamber of any one of claims 1-16, further comprising an inflatable skeleton such that upon inflation thereof it spreads the structural body and defines its unfolded shape.
18. The hyperbaric chamber of claim 17, wherein the inflatable skeleton comprises a top inflatable toroid and a bottom inflatable toroid linked by two or more longitudinal tubes, the inflatable toroids define an inner volume radius of the chamber and the inflatable tubes define an inner volume longitudinal length.
19. The hyperbaric chamber of claim 18, wherein the toroids are disposed within the inner volume to internally support the structural body.
20. The hyperbaric chamber of any one of claims 18-19, wherein the one or more inflatable tubes extending from the inflatable toroid and substantially orthogonal thereto.
21. The hyperbaric chamber of any one of claims 18-20, wherein the one or more inflatable tubes extend, at least partially, external to the inner volume to externally support the structural body.
22. An inclination assembly for supporting a foldable inflatable hyperbaric chamber, comprising:
   an elongated support arrangement extending between first and second ends and configured for coupling with the foldable inflatable hyperbaric chamber, said support arrangement comprises a rigid frame defining a frame enclosure sized for supporting said foldable inflatable hyperbaric chamber;
   an inclination mechanism for allowing controlling the inclination of the elongated support arrangement along a range of inclination positions.
23. The inclination assembly of claim 22, wherein the elongated support arrangement comprises one or more supporting sheets fixed to the rigid frame to fit within at least a portion of the frame enclosure.
24. The inclination assembly of claim 22 or 23, wherein the first end is pivotally coupled to a first anchoring structure, and the inclination mechanism is pivotally coupled to a coupling portion of the rigid frame other than the first end.
25. The inclination assembly of claim 24, wherein the coupling portion is defined between the first and second ends, more proximal to the second end.
26. The inclination assembly of claim 24 or 25, wherein the inclination mechanism is formed of two segments pivotally coupled to one another at a segment coupling portion, the first segment is coupled to the coupling portion other than the segment coupling portion, and the second segment is coupled to a second anchoring structure other than the segment coupling portion.
27. The inclination assembly of claim 26, wherein the inclination mechanism is switchable between two inclination positions, a first inclination position forms a selected angle between a frame plane defined by the rigid frame and a horizontal plane, a second inclination position in which the frame plane is co-planar with the horizontal plane.
28. The inclination assembly of claim 27, wherein segment coupling portion is configured to engage the ground in the second inclination position to provide additional support.
29. The inclination assembly of any one of claims 26-28, comprising a container sized for containing said inclination assembly, said container comprises said first and second anchoring structures.
30. The inclination assembly of any one of claims 22-29, wherein the rigid frame is formed of a plurality of rigid frame members coupled to one another.
31. A foldable inflatable hyperbaric chamber comprising:
   a structural body enclosing an inner volume at least partially formed by a collapsible flexible reinforcing mesh coated by a polymer material layer; wherein the reinforcing mesh is formed by connected strands of one or more synthetic fibers defining closely spaced frames therebetween:
wherein each frame comprises a respective portion of the polymer material therein, thereby forming viewports:
   a sealable opening for allowing a subject to enter and exit said inner volume of the hyperbaric chamber.
32. A foldable inflatable hyperbaric chamber comprising:
   a structural body that comprises:
      at least semi-transparent polymeric material layer allowing visualization therethrough, and
      a reinforcing mesh made embedded within the polymeric material layer that is formed by connected strands of one or more synthetic fibers defining closely spaced frames therebetween:
   a sealable opening for allowing a subject to enter and exit an inner volume of the hyperbaric chamber.
33. A foldable inflatable hyperbaric chamber comprising:
   a structural body comprises at least one first, non-transparent region and at least one second, at least partially transparent region,
      the first region comprises a sheet of a first reinforcing flexible material coated by a first polymeric material on one or two of its sides/faces such to yield fluid-impermeable region,
      the second region comprises an internal sheet of a second, at least partially transparent, polymeric material and an external sheet of reinforcing mesh of a second reinforcing flexible material that is formed by connected strands of one or more fibers of said second reinforcing flexible material defining closely spaced frames therebetween,
      the first and the second sheets of each second region are attached to portions of the first region forming together a fluid-impermeable structural body; and
   a sealable opening for allowing a subject to enter and exit an inner volume of the hyperbaric chamber.
34. The hyperbaric chamber of claim 33, wherein the first reinforcing material and the second reinforcing material are the same.
35. The hyperbaric chamber of claim 33 or 34, wherein each of the first and the second reinforcing materials are independently selected from: Kevlar (aramid or para-aramid), nylon, polyester and Ultra-high-molecular-weight polyethylene (UHMWPE).
36. The hyperbaric chamber of any one of claims 33-35, wherein the first polymeric material and the second polymeric material are the same.
37. The hyperbaric chamber of any one of claims 33-36, wherein each of the first and second polymeric materials are flexible and air impermeable.
38. The hyperbaric chamber of any one of claims 33-37, wherein each of the first and second polymeric materials are independently selected from: Thermoplastic polyurethane (TPU).
39. The hyperbaric chamber of any one of claims 33-38, wherein the structural body is cylindrical.
40. The hyperbaric chamber of any one of claims 33-39, comprising two structural covers attached to opposite sides of the structural body along respective attachment portions, thereby the two structural covers and the structural body confining said inner volume.
41. The hyperbaric chamber of claim 40, wherein said two structural covers have a hemi-spherical shape when the chamber is inflated.
42. The hyperbaric chamber of claim 40 or 41, further comprising one or more reinforcing rings applied on at least a part of the coupling portion.
43. The hyperbaric chamber of claim 40 or 41, wherein the attachment portions comprises
   one or more first elastic bands applied on one of the faces of the structural body and
   one or more second elastic bands applied on one of the faces of the structural covers,
   a plurality of sewing patterns, each sewing together a first band to a second band via all faces of the structural body and the respective structural cover.
44. The hyperbaric chamber of claim 43, wherein the one or more first elastic bands are applied on the external face of the structural body.
45. The hyperbaric chamber of claim 43 or 44, wherein each sewing pattern is a closed shape.
46. The hyperbaric chamber of any one of claims 43-45 wherein the first elastic band is a single band applied on the entire perimeter of the structural body.
47. The hyperbaric chamber of any one of claims 43-46 wherein the second elastic band is a single band applied to the perimeter of the structural covers.
48. The hyperbaric chamber of any one of claims 33-47, further comprising one or more of: an air/oxygen flow valve, an over-pressure relief valve or ventilation valve
49. The hyperbaric chamber of any one of claims 33-48, further comprising one or more of: an oxygen sensor, a temperature sensor or a pressure sensor.
50. The hyperbaric chamber of any one of claims 33-49, wherein the sealable opening further comprising a first zip fastener configured to prevent gas passage between the structural body and its surroundings.
51. The hyperbaric chamber of any one of claims 33-50, wherein the sealable opening further comprising a second zip fastener configured to withstand stress forces experienced by the chamber when inflated by gas.
52. The hyperbaric chamber of any one of claims 33-51, wherein the sealable opening is located at the first region.
53. The hyperbaric chamber of any one of claims 33-52, wherein the reinforcing mesh is woven.
54. The hyperbaric chamber of claim 53, wherein the reinforcing mesh is woven utilizing a Leno weave technique.
55. The hyperbaric chamber of claim 53 or 54, wherein the reinforcing mesh is at least coated with a third polymeric material to stiffen the mesh formation.
56. The hyperbaric chamber of any one of claims 33-55, wherein the synthetic fibers are Aromatic polyamide fibers.
57. The hyperbaric chamber of any one of claims 33-56, wherein the first region is prepared by a Calendaring process.
58. The hyperbaric chamber of any one of claims 33-57, comprising an adjustable seat configured to support the subject.
59. The hyperbaric chamber of claim 58, wherein the adjustable seat is anchored to at least one anchoring point at the structural body, the seat comprises at least one joint portions for allowing adjusting position or inclination thereof.
60. The hyperbaric chamber of claim 58 or 59, wherein the adjustable seat is configured to be adjusted between a standby state, in which at least part of it protrudes from the inner volume and an operation state, in which the seat is entirely accommodated within the inner volume.
61. The hyperbaric chamber of any one of claims 33-60, wherein the structural body is configured to withstand a relative air pressure of up to approximately 9 bar.
62. The hyperbaric chamber of any one of claims 33-61, further comprising an inflatable skeleton such that upon inflation thereof it spreads the structural body and defines its unfolded shape.
63. The hyperbaric chamber of claim 62, wherein the inflatable skeleton comprises a top inflatable toroid and a bottom inflatable toroid linked by two or more longitudinal tubes, the inflatable toroids define an inner volume radius of the chamber and the inflatable tubes define an inner volume longitudinal length.
64 The hyperbaric chamber of claim 63, wherein the toroids are disposed within the inner volume to internally support the structural body.
65. The hyperbaric chamber of any one of claims 63-64, wherein the one or more inflatable tubes extending from the inflatable toroid and substantially orthogonal thereto.
66. The hyperbaric chamber of any one of claims 63-65, wherein the one or more inflatable tubes extend, at least partially, external to the inner volume to externally support the structural body.
67. The hyperbaric chamber of any one of claims 33-66, comprising a grid of reinforcing bands embracing the portions of the first and second regions.
68. A foldable inflatable hyperbaric chamber comprising:
   a structural body;
   two structural covers attached to two opposite sides/ends of the structural body along respective attachment portions, thereby confining together with the structural body an inner volume; and a sealable opening for allowing a subject to enter and exit an inner volume of the hyperbaric chamber;
   wherein the attachment portions comprises
   one or more first elastic bands applied on one of the faces of the structural body and
   one or more second elastic bands applied on one of the faces of the structural covers,
   a plurality of sewing patterns, each sewing together a first band to a second band via all faces of the structural body and the respective structural cover.
69. The hyperbaric chamber of claim 68, wherein the one or more first elastic bands are applied on the external face of the structural body.
70. The hyperbaric chamber of claim 68 or 69, wherein each sewing pattern is a closed shape.
71. The hyperbaric chamber of any one of claims 68-70 wherein the first elastic band is a single band applied on the entire perimeter of the structural body.
72. The hyperbaric chamber of any one of claims 68-71 wherein the second elastic band is a single band applied to the perimeter of the structural covers.
73. An assembly for supporting a foldable inflatable hyperbaric chamber and allowing inclination adjustment of the chamber, comprising:
   a base;
   one or more arms coupled to said base and are configured to be coupled with one or more coupling locations at the external surface of said hyperbaric chamber;
   wherein said one or more arms are adjustable between various states, which the combination of the states of different arms, defines the inclination of the chamber.
74. The assembly of claim 73, comprising one or more auxiliary arms connecting two or more of said coupling locations.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a foldable inflatable hyperbaric chamber, in accordance with the presently disclosed subject matter:

FIG. 2A is a front view of the foldable inflatable hyperbaric chamber illustrated in FIG. 1:

FIG. 2B is a rear view of the foldable inflatable hyperbaric chamber illustrated in FIG. 1:

FIG. 2C is a schematic illustration of an inflatable spreading structure of the foldable inflatable hyperbaric chamber illustrated in FIG. 1:

FIG. 2D is a schematic illustration of a top view the inflatable spreading structure of the foldable inflatable hyperbaric chamber illustrated in FIG. 1:

FIG. 3A is a cross-sectional side view of the foldable inflatable hyperbaric chamber illustrated in FIG. 1:

FIG. 3B is a schematic illustration of an adjustable seat of the foldable inflatable hyperbaric chamber illustrated in FIG. 1:

FIG. 4A is a pictorial illustration of a reinforcing mesh of the foldable inflatable hyperbaric chamber illustrated in FIG. 1:

FIG. 4B is a schematic illustration of the reinforcing mesh of the foldable inflatable hyperbaric chamber illustrated in FIGS. 1 and 4A:

FIG. 4C is a schematic illustration of a longitudinal cross-sectional of the reinforcing mesh when pressure is applied on the viewports that are defined in the reinforcing mesh;

FIG. 5A is a schematic illustration of an inclination assembly configured for supporting the foldable inflatable hyperbaric chamber illustrated in FIG. 1, in accordance with the presently disclosed subject matter:

FIG. 5B is a schematic illustration of a container configured for accommodating the foldable inflatable hyperbaric chamber illustrated in FIG. 1 and/or the inclination assembly illustrated in FIG. 5A, in accordance with the presently disclosed subject matter:

FIG. 5C is a schematic illustration of a side view of the inclination assembly, illustrated in FIG. 5A, in a first exemplary inclination position, in accordance with the presently disclosed subject matter; and

FIG. 5D is a schematic illustration of a side view of the inclination assembly, illustrated in FIG. 5A, in a second exemplary inclination position, in accordance with the presently disclosed subject matter.

FIG. 6 is is a schematic illustration of an embodiment of the hyperbaric chamber according to an aspect of the present disclosure.

FIGS. 7A-7C are schematic illustrations exemplifying an entrance of a subject into the chamber, using the transition of the states of the seat between an extracted state and a retracted state.

FIG. 8 is an illustration exemplifying the attachment between a structural cover and the structural body.

FIGS. 9A-9B are schematic illustration of different views of an exemplary embodiment of an assembly for supporting a foldable inflatable hyperbaric chamber and allowing inclination adjustment of the chamber. FIG. 9A is a side view; FIG. 9B is a front view.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the figures and descriptions set forth, identical reference numerals indicate those components that are common to different embodiments or configurations. Further, it will be appreciated that for simplicity and clarity of illustration, elements shown in the figures have not necessarily been drawn to scale. For example, the dimensions of some of the elements may be exaggerated relative to other elements for clarity.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

According to certain embodiments of the presently disclosed subject matter, there is provided a foldable inflatable hyperbaric chamber for, inter alia, providing hyperbaric-oxygen environment therein intended for regeneration and therapeutic purposes.

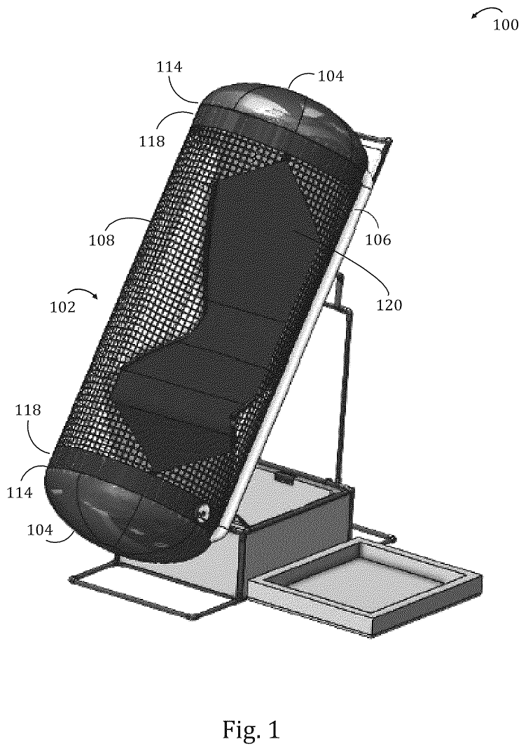

Bearing this in mind, attention is drawn to FIG. 1, a schematic illustration of a foldable inflatable hyperbaric chamber 100, in accordance with the presently disclosed subject matter.

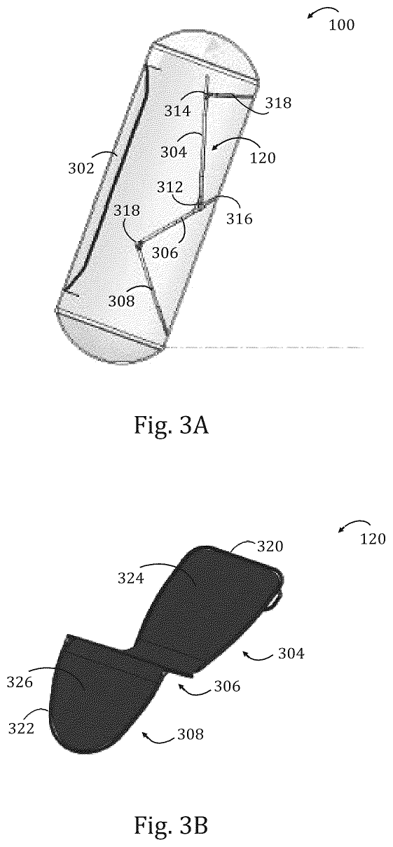

The foldable inflatable hyperbaric chamber 100 (also referred to herein as “chamber”) includes a structural body 102 with a sealable opening 302 (shown in FIG. 3A) formed thereon, two hemi-spherical structural elements 104 and an inflatable spreading structure 106, all being integrated to form the chamber 100.

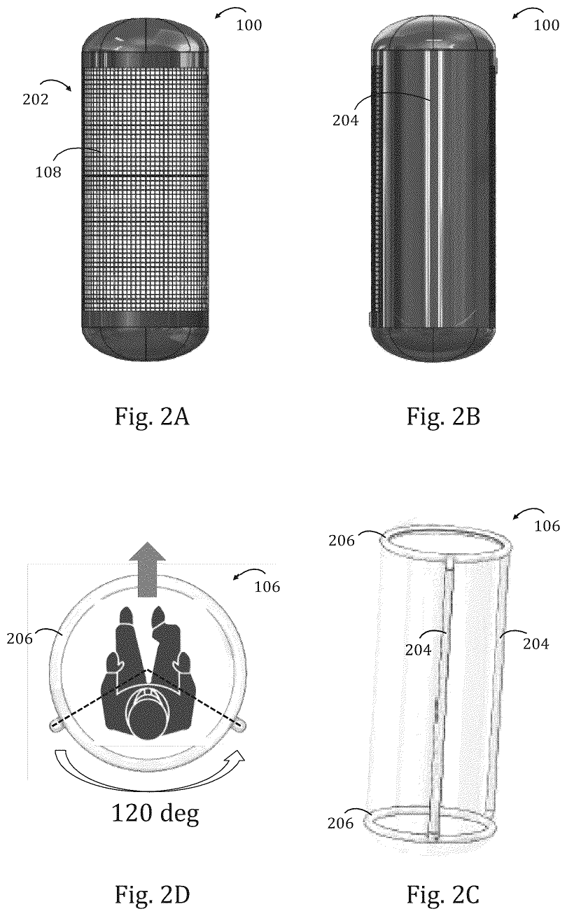

According to certain embodiments of the presently disclosed subject matter, the structural body 102 having a substantially tubular shape, when inflated with gas. It can be formed by two segments of flexible material(s) firmly coupled (e.g., sewed and welded) therebetween at their edges to form the substantially tubular shape, as can be seen in FIG. 1. A first segment of flexible material can form a back portion 204 of the chamber 100 while a second segment of flexible material can form a front portion 202 of the chamber 100. Said front 202 and back 204 portions are best seen in FIGS. 2A and 2B, respectively. By way of non-limiting example, the flexible material of the first segment can be a Kevlar®; fabric coated with Thermoplastic Polyurethane (TPU) on both sides thereof. Such configuration delivers a lightweight segment with high tensile strength required in a pressurized environment (e.g., environment under pressure of up to 10[atm]). High tensile strength may be for example withstanding longitudinal stress of approximately 180[Mpa] and hoop stress of approximately 360[Mpa]. In another example, a fraction of 5 cm fabric can experience hoop forces of approximately 1.8 ton and longitudinal forces of approximately 0.9 ton.

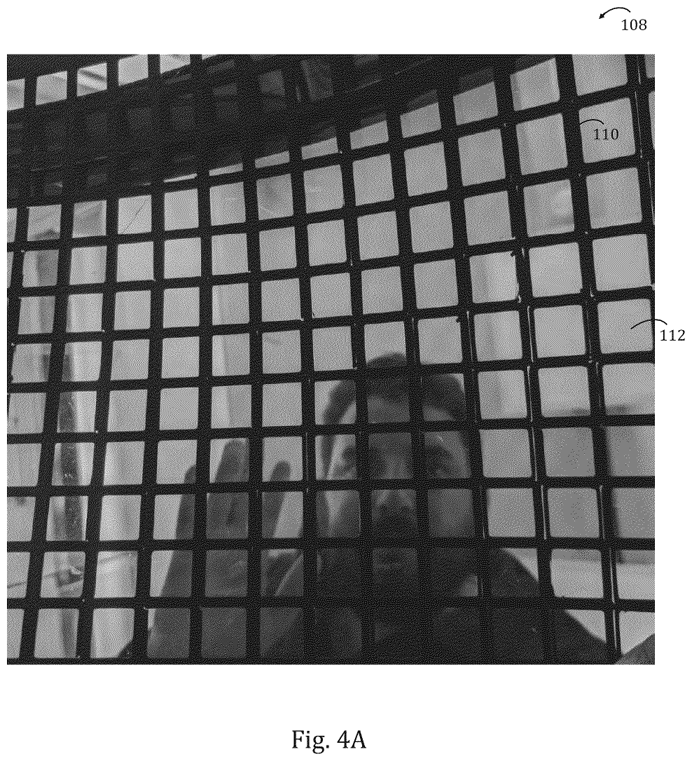

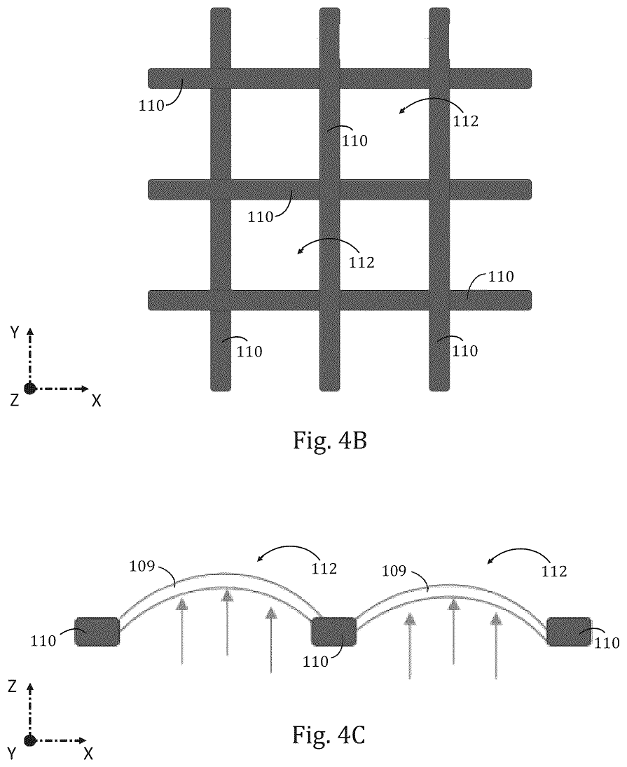

The second segment of the flexible material, that may form the front portion 202 of the chamber 100, can be made of a reinforcing mesh 108 (also referred to herein as “mesh”) embedded within a polymeric material layer 109 (best seen in FIG. 4). The mesh 108 is formed of connected strands 110 of one or more synthetic fibers defining closely spaced frames 112 therebetween (best seen in FIG. 4). The closely spaced frames 112 are serving as viewports of the chamber 100 that are used as windows in order to enable visualization therethrough (e.g., by a chamber 100 operator and/or medical attendant, to view the patients inside the chamber and vice versa). For this purpose, the polymeric material layer that is used to form the mesh can be at least semi-transparent (e.g., with respect to the visible spectrum) polymer allowing visualization therethrough. The polymer may be for example a Thermoplastic polyurethane (TPU). FIG. 4 provides a pictorial illustration of an exemplary reinforcing mesh 108 (a fraction thereof) as it can be seen by a subject that is located inside the chamber 100. As can be seen in FIG. 4, the polymeric material layer formed at the spaces between the connected strands 110 of the mesh 108 enables visualization therethrough. Such configuration of the mesh 108 prevents potential failure of the viewports 112 under pressure. By way of non-limiting example, the mesh 108 configuration may be formed of strands with a thickness greater than 1 mm and viewports 112 of 15×15 mm in size.

Synthetic fibers forming the strands can be made from, by way of non-limiting example. Aromatic polyamide materials (also known as Aramid fibers. e.g., Kevlar® fibers. Nomex® fibers, etc.). It is to be noted that in other cases, other materials and/or combinations thereof can be used to make the synthetic fibers.

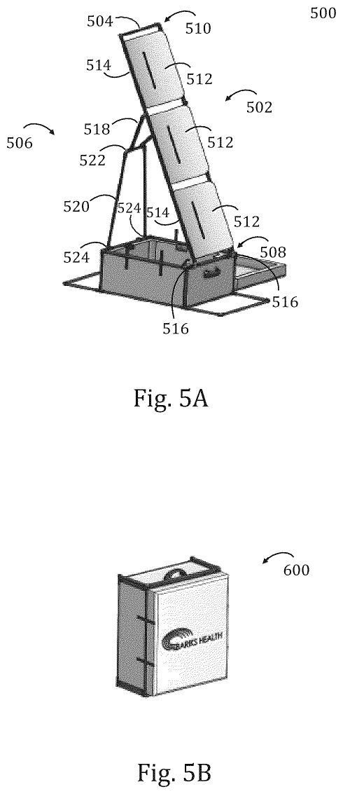

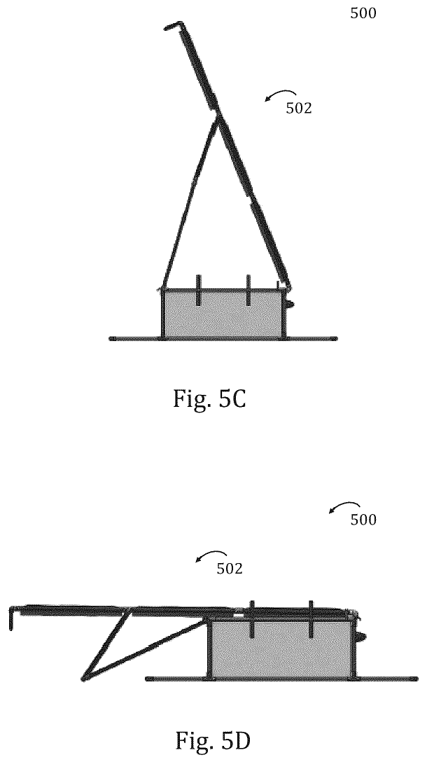

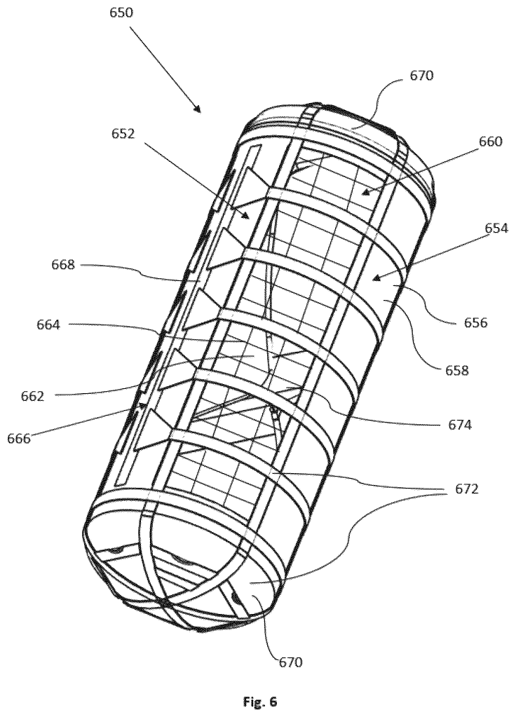

It is to be noted that the chamber 100 is made of light weight, flexible materials (e.g., as described herein) and could be folded to a small volume, as optionally described herein below with respect to FIG. 5B, which shows a container that is sized and shaped to contain the folded chamber.

In some cases, the mesh 108 can be woven utilizing a Leno weave technique, known to ordinary person skilled in the art, which enables a geometric stability of the reinforcing mesh 108 structure. That is, the mesh does not substantially deform and fail under high pressure (e.g., 10 atm).

In some cases, the mesh 108 can be embedded within the polymeric material layer by a Calendering process.

The chamber 100 includes two flexible hemi-spherical structural elements 104 that are firmly coupled (e.g., sewed and welded) to opposite sides of the structural body 102 at coupling portions thereof 114. The two hemi-spherical structural elements 104 and the structural body 102 are enclosing an inner volume of the chamber 100. Said inner volume can be entered or exited through the sealable opening 302 by a subject. By way of non-limiting example, the flexible hemi-spherical structural elements 104 can be made from a flexible material such as a Kevlar® fabric coated with Thermoplastic Polyurethane (TPU) on both sides thereof. In some cases, the sealable opening 302 can include a first zip fastener that is configured to prevent gas passage between the structural body 102 (e.g., the inner volume) and its surroundings. In some other cases, the sealable opening 302 can include a second zip fastener that is configured to withstand stress forces experienced by the chamber 100 when inflated by pressurized gas. It is to be noted that utilizing zip fasteners is by no means limiting and the teachings herein can be performed utilizing any other sealing and/or fastening techniques (e.g., buckle fasteners) and/or combinations thereof, mutatis mutandis.

According to certain embodiments of the presently disclosed subject matter, the sealable opening 302 can be located on the second segment of the flexible material, that may form the front portion 202 of the chamber 100. That is, the sealable opening 302 can be formed entirely on the reinforcing mesh 108. Such configuration enables convenient entry and egress of the subject into/from the inner volume. In some cases, at least portion of the sealable opening 302 can be formed on the mesh 108. That is, the sealable opening 302 can extend from the mesh 108 portion to the back portion of the structural body 102.

In some cases, the chamber 100 can further include one or more reinforcing rings 118 applied on at least a part of the coupling portions 114 of the chamber 100. Said reinforcing rings 118 are configured to provide additional circumferential sealing layer to areas where the hemi-spherical structural elements 104 are connected to the structural body 102. By way of non-limiting example, the reinforcing rings 118 can be made from a Kevlar® fabric coated with Thermoplastic Polyurethane (TPU) on both sides thereof.

According to certain embodiments of the presently disclosed subject matter, the chamber 100 can operate with a maximum working gas pressure of approximately 10 atm (that is, the chamber 100 can maintain an interior gas pressure of approximately 10 atm). Accordingly, the structural body 102 is configured to withstand a relative air pressure of up to approximately 9 bar (e.g., the relative pressure between the inner volume of the chamber 100 and the ambient pressure thereof, such as for example, the pressure at sea level which is typically approximately 1 atm).

In some cases, the chamber 100 can further include one or more of: an air/oxygen flow valve, an over-pressure relief valve or ventilation valve. For instance, the ventilation valve can be configured to ventilate the gas inside the chamber 100 at a rate of 30 liters/min. In some cases, said one or more valves can be located on the structural body 102 portion of the chamber 100. Additionally, the chamber 100 can further include a control panel configured to, inter alia, automatically control operation of the one or more valves (e.g., open and close), regulate oxygen supply to hoods or masks (where applicable) that may be worn by the subject while being inside the chamber 100, etc.

In some cases, the chamber 100 can further include one or more sensors, such as but not limited to, an oxygen sensor, a temperature sensor or a pressure sensor, that may be located on the structural body 102 portion of the chamber 100. The control panel can be configured to control operation of the one or more valves based on readings from the one or more sensors. In some cases, the one or more valves and/or sensors may be operated manually.

The inflatable spreading structure 106 (also referred to herein as “skeleton”) of the chamber 100 is illustrated separately in FIG. 2C. As can be seen in FIG. 2C, the skeleton 106 may be formed of two inflatable toroids 206 (e.g., a top inflatable toroid and a bottom inflatable toroid) spaced apart by two inflatable tubes 204 extending therebetween and substantially orthogonal thereto. The two inflatable tubes 204 extend along a longitudinal axis and their length defines the height of the skeleton 106, and the radiuses of the inflatable toroids 206 define the radial dimension of the skeleton 106. The skeleton 106 can be inflated to expand and support the chamber 100 to maintain its substantially tubular shape, before and after the chamber 100 is inflated with pressurized gas (that is, the inflatable skeleton, upon inflation thereof, can spread the structural body 102 and define its unfolded shape). Moreover, it enables a convenient entry and egress of the subject into the chamber 100 before commencing the hyperbaric treatment and after completing the treatment. The inflatable tubes 204 can be connected to the inflatable toroids 206 at any location along their circumference. For instance, the inflatable tubes 204 can be connected to the inflatable toroids 206 at locations defining a predetermined angle therebetween, such as but not limited to, 120 degrees. Such exemplary configuration is illustrated in FIGS. 2C and 2D. This way, the inflatable tubes 204 do not interfere with subject's field of view while he is located inside the chamber 100. As can be seen in FIG. 1 for example, the toroids can be disposed within the inner volume of the chamber 100 to internally support the structural body 102. In some cases, the toroids can be disposed outside the chamber 100 to externally support the structural body 102. Additionally, the one or more inflatable tubes 204 can extend, at least partially, external to the inner volume, to externally support the structural body 102. In some cases, the one or more inflatable tubes 204 can extend internally along the inner volume, to internally support the structural body 102.

Referring to FIGS. 3A and 3B, the structural body 102 can further include an adjustable seat 120 configured to support the subject during his hyperbaric treatment inside the chamber 100. The seat 120 can include a backrest portion 304, a seat portion 306 and a footrest extension 308, all being integrated to form the adjustable seat 120. The backrest portion 304 can be pivotably connected to the seat portion 306 via a first joint portion 312, and thereby each may be rotated about the first joint portion 312. Additionally, the adjustable seat 120 may include a backrest supporting member 318 configured to enable backrest 304 angle adjustment. For this purpose, the backrest supporting member 318 can be pivotably connected to the backrest portion 304 via a second joint portion 314, and thereby can be rotated about the second joint portion 314. The footrest extension 308 can be pivotably connected to the seat portion 306 via a third joint portion 318, and thereby each can be rotated about the third joint portion 318.

Such configuration of the adjustable seat 120 can offer the subject a free movement between one or more relaxed reclining positions, that can be adjusted before and/or during the hyperbaric treatment inside the chamber 100. This can be achieved by rotating one or more adjustable seat 120 portions (e.g., the backrest portion 304, seat portion 306, footrest extension 308 and/or backrest supporting member 318) about their respective joint portions (e.g., the first joint portion 312, second joint portion 314 and/or third joint portion 318) which allows adjusting position or inclination of the respective adjustable seat portion.

In some cases, the adjustable seat 120 can be anchored to at least one anchoring point at the structural body 102, e.g., anchoring point 316. This may secure the seat 120 to the chamber 100 and prevent its movement (e.g., sliding, falling down, etc.) when the chamber 100 is in a substantially vertical position and/or inclination with respect to the ground surface (e.g., substantially vertical positions as illustrated in FIGS. 1, 2A, 2B and 3A).

Each adjustable seat 120 portion (e.g., the backrest portion 304, seat portion 306, footrest extension 308 and/or backrest supporting member 318) may be formed of a respective rolled pipe frame. For example, frames 320 and 322 of the backrest portion 304 and footrest extension 308, respectively, as illustrated in FIG. 3B. Some of the adjustable seat 120 portions (e.g., the backrest portion 304, seat portion 306 and footrest extension 308) may further include a respective textile sheet configured to fit within at least a portion of a respective frame enclosure. For example, textile sheet 324 and 326 of the backrest portion 304 and footrest extension 308, respectively, as illustrated in FIG. 3B. In some cases, the textile sheet can be one continuous sheet extending throughout the adjustable seat 120 and bounded by the respective frame enclosures.

Such configuration of rolled pipe frames integrates with the substantially tubular shape of the structural body 102 and thereby may create a continuous line of contact therewith which distributes the pressure or tension exerted thereon.

According to certain embodiments of the presently disclosed subject matter, upon completion of the hyperbaric treatment, the adjustable seat 120 can be manually detached from the structural body 102 and swiftly folded to a compact portable configuration and vice versa.

Referring to FIG. 5A, there is shown a schematic illustration of an inclination assembly 500 configured for supporting the foldable inflatable hyperbaric chamber 100 illustrated in FIG. 1, in accordance with the presently disclosed subject matter.

The inclination assembly 500 includes an elongated support arrangement 502 and an inclination mechanism 506. The elongated support arrangement 502 is extending between a first end 508 and a second end 510 thereof and is configured for coupling with the foldable inflatable hyperbaric chamber 100 (as shown for example in FIG. 1). The support arrangement 502 includes a rigid frame 504 defining a frame enclosure sized for supporting the chamber 100 while it is being coupled thereto. In some cases, the support arrangement 502 further includes one or more supporting sheets 512. The sheets 512 can be fixed to the rigid frame 504 and configured to fit within at least a portion of the frame enclosure. Said supporting sheets 512 are configured to support the chamber 100, inter alia, during varying inclination angles thereof, as further described herein. By way of non-limiting example, the sheets 512 can be made from a flexible material such as a Kevlar® fabric coated with Thermoplastic Polyurethane (TPU) on both sides thereof. It is to be noted that other fabrics and/or textile materials can be used to make the supporting sheets 512. In some cases, the rigid frame 504 can include a rigid arc, instead of the supporting sheets 512, that can be fixed to the rigid frame 504 and configured to fit therewithin to support the chamber 100 while it is being coupled thereto (e.g., the chamber 100 can be fixed to the rigid frame 504 and/or to the arc). By way of non-limiting example, the arc can be located on the rigid frame 504 so that it can be coupled to anchoring point 316 that is illustrated in FIG. 3A.

It is to be noted that utilizing supporting sheets 512 is by no means limiting and the teachings herein can be performed utilizing any other supporting means and/or techniques, mutatis mutandis.

In some cases, the rigid frame 504 can be formed of a plurality of rigid frame members 514 coupled to one another. That is, the rigid frame 504 can be assembled or disassembled by connecting the plurality of rigid frame members 514 to one another, to form the frame 504. By way of non-limiting example, the frame members 514 can be carbon rods configured to withstand a weight of the chamber 100 while it is accommodated by a subject therein.

The inclination mechanism 506 allows to control the inclination of the elongated support arrangement 502, and thereby the inclination of the chamber 100 when it is coupled thereto, along a range of inclination positions. For instance. FIG. 5C illustrates a first exemplary inclination position wherein the elongated support arrangement 502 forms a 70-degree angle with the ground level. The first inclination position can be utilized for example when the adjustable seat 120 is configured in a sitting position (e.g., as illustrated in FIG. 3A). FIG. 5D illustrates a second exemplary inclination position wherein the elongated support arrangement 502 forms a 0-degree angle with the ground level. The second inclination position can be utilized for example when the adjustable seat 120 is configured in a reclining position (e.g., a position wherein the backrest portion 304, seat portion 306, footrest extension 308 and backrest supporting member 318 form a substantially uniform surface, not shown in the drawings).

In order to enable changing the inclination positions of the elongated support arrangement 502, the first end 508 thereof can be pivotally coupled (e.g., by coupling two rigid frame members 514) to a first anchoring structure 516. Additionally, inclination mechanism 506 can be pivotally coupled to a coupling portion of the rigid frame 504, other than the first end 508. For this purpose, the coupling portion can be defined between the first end 508 and the second end 510 of the rigid frame 504, in some cases more proximal to the second end 510 (as for example illustrated in FIGS. 5A, 5C and 5D).

In some cases, the inclination mechanism 506 can be formed of two segments 518, 520 pivotally coupled to one another at a segment coupling portion 522. The first segment 518 can be pivotally coupled to a coupling portion of the rigid frame 504, other than the segment coupling portion 522. The second segment 520 can be pivotally coupled to a second anchoring structure 524 other than the segment coupling portion 522. Such configuration enables rotation of each of the segments 518, 520 about their respective coupling portions, as further described herein below with respect to FIGS. 5C-5D.

FIG. 5B illustrates an exemplary container 600 configured for accommodating at least the foldable inflatable hyperbaric chamber 100 or the inclination assembly 500, in accordance with the presently disclosed subject matter. For this purpose, the container 600 is sized for containing the chamber 100 or the inclination assembly 500, or both. In some cases, more than one container 600 can be utilized (e.g., one container can accommodate the chamber 100 and second container can accommodate the inclination assembly 500). Accordingly, the inclination assembly 500 and the chamber 100 can be disassembled and/or folded so that all parts thereof can be placed inside one or more containers for transportation and/or compact storage purposes. This facilitates portability of the chamber 100 to remote locations wherein a hyperbaric treatment is required. In some cases, the container 600 can be sized to fit inside a car trunk. Additionally, the inclination assembly 500 and the chamber 100 can be assembled and/or deployed when needed. Accordingly, the chamber 100 can be assembled and disassembled repeatedly. e.g., dozens, hundreds and even thousands number of times.

According to certain embodiments of the presently disclosed subject matter, the container 600 can include the first anchoring structure 516 and the second anchoring structure 524, configured to enable aforesaid coupling.

Attention is now drawn to FIGS. 5C and 5D, illustrating a side view of the inclination assembly 500 in first and second exemplary inclination positions, respectively, in accordance with the presently disclosed subject matter.

In some cases, the inclination mechanism 506 can be switchable between two inclination positions:
(a) a first inclination position (e.g., as illustrated in FIG. 5C) wherein the elongated support arrangement 502 can form a selected angle between a frame plane defined by the rigid frame 504 and a horizontal plane (e.g., the plane of the container 600). FIG. 5C illustrates a first exemplary inclination position wherein a 70-degree angle is formed between frame 504 and the horizontal plane.
(b) a second inclination position (e.g., as illustrated in FIG. 5D) wherein the elongated support arrangement 502 is coplanar with the horizontal plane. FIG. 5D illustrates a second exemplary inclination position wherein a 0-degree angle is formed between frame 504 and the horizontal plane. In some cases, the segment coupling portion 522 can be configured to engage the ground in the second inclination position. Such configuration provides additional support to the elongated support arrangement 502 in the second inclination position.

In some cases, the inclination mechanism 506 can be a pneumatic piston configured to perform teaching described herein.

Reference is now being made to FIG. 6, which is a schematic illustration of an embodiment of the hyperbaric chamber according to an aspect of the present disclosure. The chamber 650 comprises a structural body 652 formed of two different region types. A first region 654 is non-transparent and it comprises a sheet of a first reinforcing flexible material 656 and a first polymeric material 658 applied on two of the faces of the first reinforcing flexible material 656 so as to yield fluid-impermeable region, suitable for withstanding high pressure. The second region 660 comprises an internal sheet of a second polymeric material 662 and an external sheet of reinforcing mesh 664 of a second reinforcing flexible material that is formed by connected strands of the second reinforcing flexible material defining closely spaced frames therebetween allowing visualization therethrough such that a subject that is found in the interior of the chamber can see through the second region to the exterior of the chamber. Namely, the frames are window-like portions for allowing visualization therethrough. The internal sheet and the external sheet can be either independently attach to portions of the first region or can have common portions that are attached to portions of the first region. For example, only the peripheral portions of each second region part of the chamber can be attached, e.g. welded, to portions of the first region. Therefore, it can be understood that the second regions are embedded within cut portions of the first regions.

A sealable opening 666 is formed in the structural body 652 and is formed with at least one zipper 668 for allowing a subject to enter and exit an inner volume of the hyperbaric chamber 650.

The structural body is cylindrical, in the inflated state, having two opposite openings which are sealed by two opposite structural covers 670 that are sewn to the structural body 652.

A grid of reinforcing bands 672 embrace the external surface of the structural body and the structural covers to provide more durability to the chamber so it can withstand very high-pressure difference between its interior and the ambient pressure.

A seat 674 is accommodated within the internal volume 676 of the chamber confined by the structural body 652 and the structural covers 670. The seat 674 can be adjusted to assume several sitting states. This is performed by adjusting seat elements that are capable of rotation, each about a respective axis.

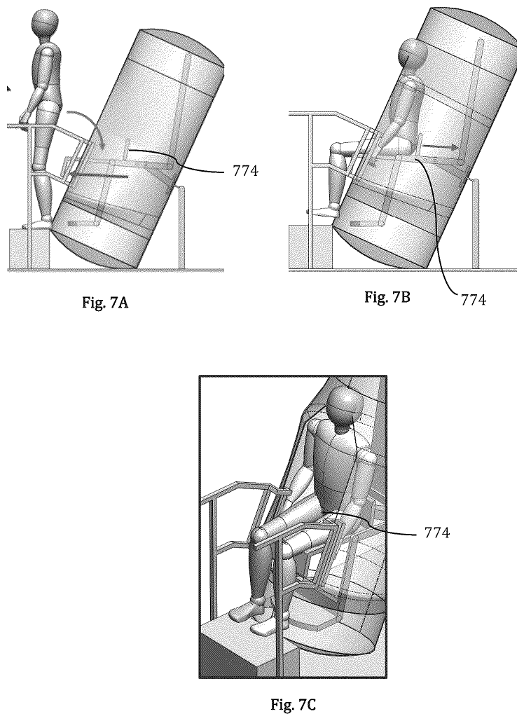

Reference is now being made to FIGS. 7A-7C, which are schematic illustrations exemplifying an entrance of a subject into the chamber. In FIG. 7A the seat 774 in the chamber is moved to the extracted position, in which a part of it is found outside of the internal volume of the chamber. This makes the sitting on the chair relatively easy for a subject accessing the chamber via a platform or without it, as can be seen in FIG. 7C. Once the subject sits on the sear, the seat can be moved to the retracted position, as exemplified by the arrow in FIG. 7B. Once in the retracted position, the sealable opening of the chamber can be sealed, and the chamber can be pressurized.

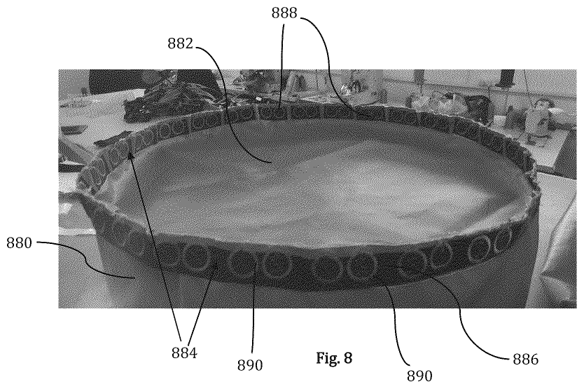

Reference is now being made to FIG. 8, which is an illustration exemplifying an attachment between one of the structural covers and the structural body. The structural body 880 and the structural cover 882 are attached one to another via an attachment portion 884 that is formed at the circumference of the structural body 880 and respective portion of the circumference of the structural cover 882. In this non-limiting example, a first elastic band 886 is applied on the external face of the structural body 880 and a plurality of segments of one or more second elastic bands 888 are applied to an external face of the structural cover 882. The first and the second elastic bands 886 and 888 are sewn to each other by sewing patterns 890 along the circumference. In this non-limiting example, the structural cover 882 forms the internal layer and the structural body 880 forms the external layer. It is to be noted, that the attachment technique can be applied to any embodiment or aspect of the hyperbaric chamber and is not limited to any specific embodiment or aspect.

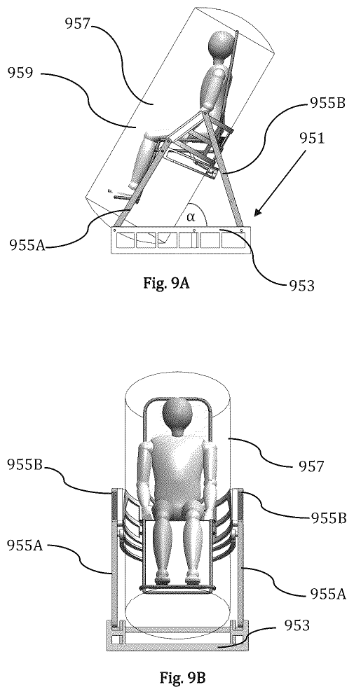

Reference are now being made to FIGS. 9A-9B, which are schematic illustration of different views of an exemplary embodiment of an assembly for supporting a foldable inflatable hyperbaric chamber and allowing inclination adjustment of the chamber. The assembly 951 comprising a base 953 that is intended to be put on the ground/floor. Two couples of arms 955A and 955B couple the base with the coupling locations formed on the external surface of the chamber 957. Each couple has arms that couple to generally opposite sides of the structural body 959 of the chamber 957. Each arm is rotatably coupled to the base 953 such that rotational position of the arms defines the inclination state of the chamber 957, namely at what angle α the chamber is found with respect to the surface of the ground. The two arms that are found at the same side of the chamber are connected by auxiliary arms via the coupling locations.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. An assembly for supporting a foldable inflatable hyperbaric chamber and allowing inclination adjustment of the chamber, comprising:
a base;
one or more arms coupled to said base and are configured to be coupled with one or more coupling locations at the external surface of said hyperbaric chamber;
wherein said one or more arms are adjustable between various states, which the combination of the states of different arms, defines the inclination of the chamber.

2. The assembly of claim 1, comprising one or more auxiliary arms connecting two or more of said coupling locations.

3. The assembly of claim 1, wherein said one or more arms comprise one or more couples of arms, each arm of the couple is coupled to a respective coupling location opposite to the coupling location of the other arm of the couple.

4. The assembly of claim 1, wherein said one or more arms are rotatably coupled to the base to allow said adjustability between various states.

5. An inclination assembly for supporting a foldable inflatable hyperbaric chamber, comprising:
an elongated support arrangement extending between first and second ends and configured for coupling with the foldable inflatable hyperbaric chamber, said support arrangement comprises a rigid frame defining a frame enclosure sized for supporting said foldable inflatable hyperbaric chamber;
an inclination mechanism for allowing controlling the inclination of the elongated support arrangement along a range of inclination positions.

6. The inclination assembly of claim 5, wherein the elongated support arrangement comprises one or more supporting sheets fixed to the rigid frame to fit within at least a portion of the frame enclosure.

7. The inclination assembly of claim 5, wherein the first end is pivotally coupled to a first anchoring structure, and the inclination mechanism is pivotally coupled to a coupling portion of the rigid frame other than the first end.

8. The inclination assembly of claim 7, wherein the coupling portion is defined between the first and second ends, more proximal to the second end.

9. The inclination assembly of claim 7, wherein the inclination mechanism is formed of two segments pivotally coupled to one another at a segment coupling portion, the first segment is coupled to the coupling portion other than the segment coupling portion, and the second segment is coupled to a second anchoring structure other than the segment coupling portion.

10. The inclination assembly of claim 9, wherein the inclination mechanism is switchable between two inclination positions, a first inclination position forms a selected angle between a frame plane defined by the rigid frame and a horizontal plane, a second inclination position in which the frame plane is co-planar with the horizontal plane.

11. The inclination assembly of claim 10, wherein segment coupling portion is configured to engage the ground in the second inclination position to provide additional support.

12. The inclination assembly of claim 9, comprising a container sized for containing said inclination assembly, said container comprises said first and second anchoring structures.

13. The inclination assembly of claim 5, wherein the rigid frame is formed of a plurality of rigid frame members coupled to one another.
